(19) United States
(12) Patent Application Publication
(10) Pub. No.: US 2013/0219015 A1
(43) Pub. Date: Aug. 22, 2013

(54) ENLARGEMENT FOR VIDEO CONTENT STREAMED FROM THE INTERNET

(71) Applicants: Lup Yuen Lee, Singapore (SG); Cheng Chuan Loo, Singapore (SG)

(72) Inventors: Lup Yuen Lee, Singapore (SG); Cheng Chuan Loo, Singapore (SG)

(21) Appl. No.: 13/806,888

(22) PCT Filed: Jun. 30, 2010
(86) PCT No.: PCT/SG2010/000243

§ 371 Date: Mar. 5, 2013

(51) Int. Cl. H04L 29/06

(52) U.S. Cl. CPC H04L 65/604
USPC 709/217

(57) ABSTRACT

This invention relates to a system for displaying video content streamed from a network in a full screen mode. The system receives receiving a network address based on a selection from a user. The system then transmits a request for content from the network address and subsequently receives the content associated with the network address. A search is performed on the content for data that provides displaying a video content in a full screen mode. Upon detecting the data, the process generates the data and displays video content in full screen mode.

### FIELD OF THE DISCLOSURE

This invention relates to providing a full screen mode of video content received from a content provider over a network. More particularly, this invention relates to activating a full screen mode automatically without receiving a user input. Still more particularly, this invention relates to searching data received from the content provider to determine a request that will invoke a full screen mode and generating the request to activate the full screen mode.

### BACKGROUND

The proliferation of Internet media content, specifically video content, has driven a desire to provide Internet content on convention television sets via interactive television systems. Interactive television systems are typically provided by set top boxes that communicate with service provider systems to provide video content to the television sets. The set top boxes often include software to provide video content that may be updated through communications with the service provider systems.

One particular problem with providing video content from the Internet on a television set is the provision of the content in a full screen mode in which the video content appears on the entire display of the television. Typically, video content provided over the internet is provided in a certain portion of a web page designated as the video player. The rest of the display of the web page includes advertisements and other features that the content provider wants to display to the user. Thus, the user cannot enjoy the advantages of being able to view the video content on the full screen of the television set.

To correct this problem, some content providers provide interactive features in a web page that allow a user to request the video content be displayed in a full screen mode. For example, the displayed page may include a “Full Screen” button that a user may select using a pointing device to invoke the full screen mode of the video content. However, this is not desirable in an interactive television system in which the user has limited input options to input such a request. Thus, the use of interactive features provided by the content providers is not a practical solution to the problem in interactive television systems.

In order to provide full screen mode of video content on a television, some systems such as the systems described in U.S. patent application Ser. No. 12/176,706 titled “Software Based Internet/Television Convergence Methods and Systems for Organizing and Displaying Internet Media Content on Computers and Television Sets” in the name of Leonov et al. published on 21 Jan. 2010; and U.S. Pat. No. 6,338,094 titled “Method, Device and System for Playing a Video File in Response to Selecting a Web Page Link” issued to Scott et al. on 8 Jan. 2002, store video content and other data from a content provider at a server or head-end of the system and transmit the data to the set-top box when the video is selected. It is a problem that these systems require the service provider to have stored versions of the video content to provide to the set-top box which limits the selections of video content to view and often cause a delay between when the content is originally provided by the content provider and when the content may be viewed by a user.

Thus, those skilled in the art are constantly striving to implement a system that will provide a full screen mode of video content from a video provider received over the Internet without the need for a user interface with the content provider and without content being stored by the service provider in order to provide a more robust selection of video content and allow users to view new content without unreasonable delays.

### SUMMARY OF THE INVENTION

The above and other problems are solved and an advance in the art is made in a system that invokes a full screen mode in accordance with this invention. A first advantage of a system in accordance with this invention is that the system may be installed in existing processing system with no additional circuitry. A second advantage of a system in accordance with this invention is that the system allows a user to view a full screen mode of video content received over the Internet in full screen mode without the user providing an input. A third advantage of a system in accordance with this invention is that, the system does not require a service provider to store the video content to provide the full screen display. A fourth advantage of a system in accordance with this invention is that the system detects the end of displayed video to prevent the display of a web page associated with the video content to allow the user to only view the video content without having to view the web page that includes the video data.

In accordance with embodiments of this invention, the system displays video content in full screen mode in the following manner. The system receives a network address and requests content from the network address. The system then receives the content associated to the network address. The received content is searched for data that provides a full screen mode. Upon determining of the data, the system generates the data and displays the video content available in the content in full screen mode.

In accordance with one of the embodiments of this invention, the data that provides a full screen mode is an input response associated with a set of coordinates corresponding to a full screen mode object in the received content.

In accordance with one of the embodiments of the invention, the search process is performed in the following manner. The process searches for the network address in a pre-stored list network addresses. The process then retrieves a set of coordinates associated with the network address found in the pre-stored list. A request associated with the set of coordinates associated with the identified network address is then transmitted to a content provider system. Full screen mode video content is then received from the content provider system in response to the request.

In accordance with one of the embodiments of the invention, the search may be performed in the following manner. The process selects a set of pre-defined coordinates and determines a perimeter of an object that contains the set of pre-defined coordinates. The process then determines whether the object is a video player window. The process then calculates a set of coordinates for an object that provides full screen mode. In accordance with one of these embodiments, the set of coordinates is calculated in the following manner. The minimum value of Y axis and maximum value of X axis of the video player window are obtained. The minimum value of Y axis and the maximum value of X axis are then subtracted by a constant Y value and X value respectively to determine the set of coordinates.

In accordance with particular ones of these embodiments, the object including the searched coordinates is determined to be a video player window in the following manner. The perimeter of the object is obtained and compared with a constant perimeter value. If the perimeter of the object is larger than the constant perimeter value, the object is determined to be a video player window.

In accordance with other embodiments of the invention, the system verifies that the video content is in the full screen mode. If the video content is not in a full screen mode, a subsequent search of the content for data that provides the full screen mode is performed using a different set of pre-defined coordinates. If the full screen mode is not provided after a pre-defined number of searches, a fault report is sent to a server.

In accordance with still other embodiments of the invention, the system reads other information associated with the data to determine whether the information contains an indication for full screen mode function. More specifically, the system obtains the information via an accessibility feature.

In accordance with other embodiments of the invention, the system displays the video content in the full screen mode in a customised browser. Upon detecting an end of the content, the system closes the customised browser. In some of these embodiments, the system detects the end of the content by monitoring network traffic transmitted to and received from the network address to detect a specific pattern in the network traffic. In particular, the system detects a request for retrieving video thumbnails sent to the content provider system.

In accordance with one of the embodiments of the invention, the system may receive a selection from a user prior to closing the customised browser. The system identifies a function associated with the selection and performs the function. The function may be one of, but not limited to, restoring the customised browser to a non-full screen mode, and closing the customised browser.

In accordance with some embodiments of the invention, the system is provided using an Application Programming Interface (API).

### BRIEF DESCRIPTION OF THE DRAWINGS

The above and other features and advantage of a process for displaying a full screen mode are described in the following Detailed Description and are shown in the following drawings:

FIG. 1 illustrating a set top box device that performs the processes for providing a full screen mode of video content connected to a network in accordance with one embodiment of this invention;

FIG. 2a illustrating an entertainment system including a set top box device shown in FIG. 1 in accordance with an embodiment of this invention;

FIG. 2b illustrating “web page” display of content from a content provider in accordance with an embodiment of this invention;

FIG. 2c illustrating a “full screen mode” display of video content from a content provider in accordance with an embodiment of this invention;

FIG. 3 illustrating a block diagram of components of a processor performing instructions to provide processes in accordance with an embodiment of this invention;

FIG. 4 illustrating a flow diagram for a process for displaying full screen mode in accordance with an embodiment of this invention;

FIG. 5 illustrating a flow diagram for a process for searching a set of coordinates in accordance with an embodiment of this invention; and

FIG. 6 illustrating a flow diagram for a process for determining for a set of coordinates in accordance with another embodiment of this invention.

### DETAILED DESCRIPTION

This invention relates to providing a full screen mode of video content received from a content provider over a network. More particularly, this invention relates to activating a full screen mode automatically without receiving a user input. Still more particularly, this invention relates to searching data received from the content provider to determine a request that will invoke a full screen mode and generating the request to activate the full screen mode. For ease of reference and clarity, components shown in more than one drawing are given the same reference numeral in each drawing.

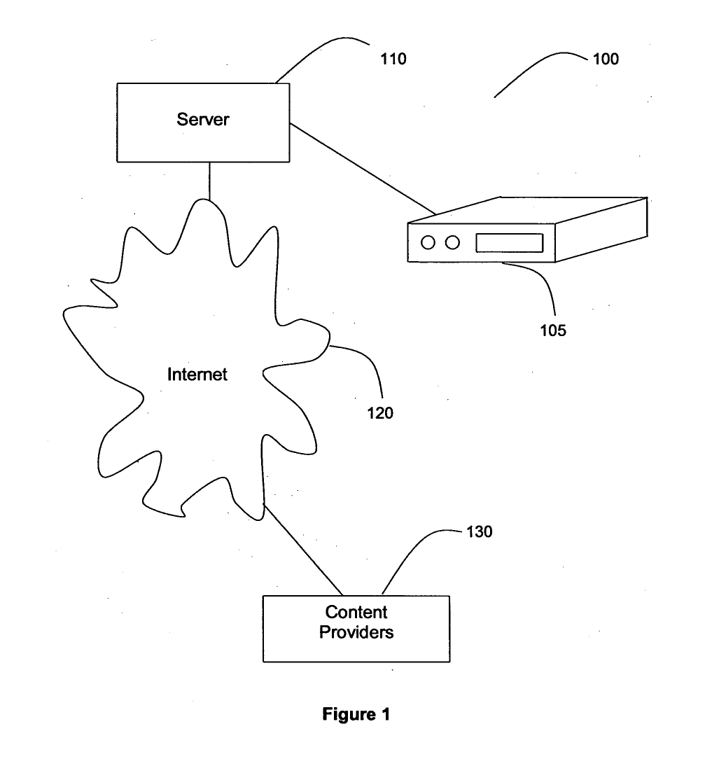

FIG. 1 illustrates network 100 that includes server 110 and content provider processing systems 130. Server 110 is a conventional server that performs the functions of storing data for and transferring data to set top box 10 in accordance with an embodiment of the invention. Server 110 is connected to Internet 120 and/or equivalent network for communication with content provider processing systems 130. One skilled in the art will recognize that the inter-connection between server 110, set top box 105, Internet 120, and content provider processing systems 130 is either via wired or wireless connection and a complete description of the connectivity of server 110, set top box 105, Internet 120, and content provider processing systems 130 is omitted for brevity.

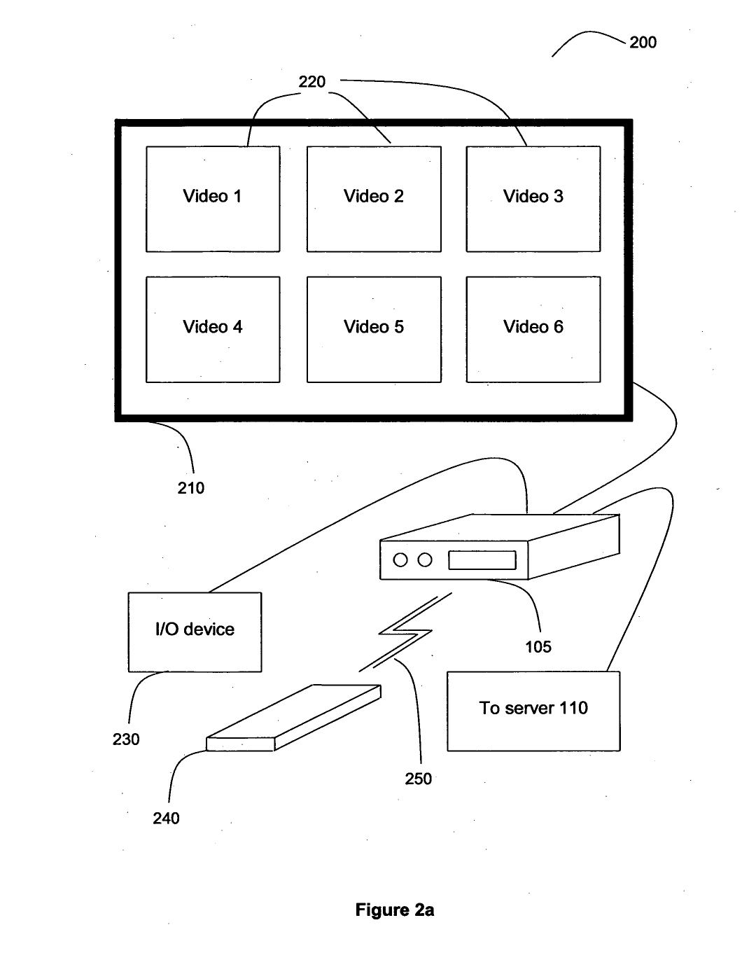

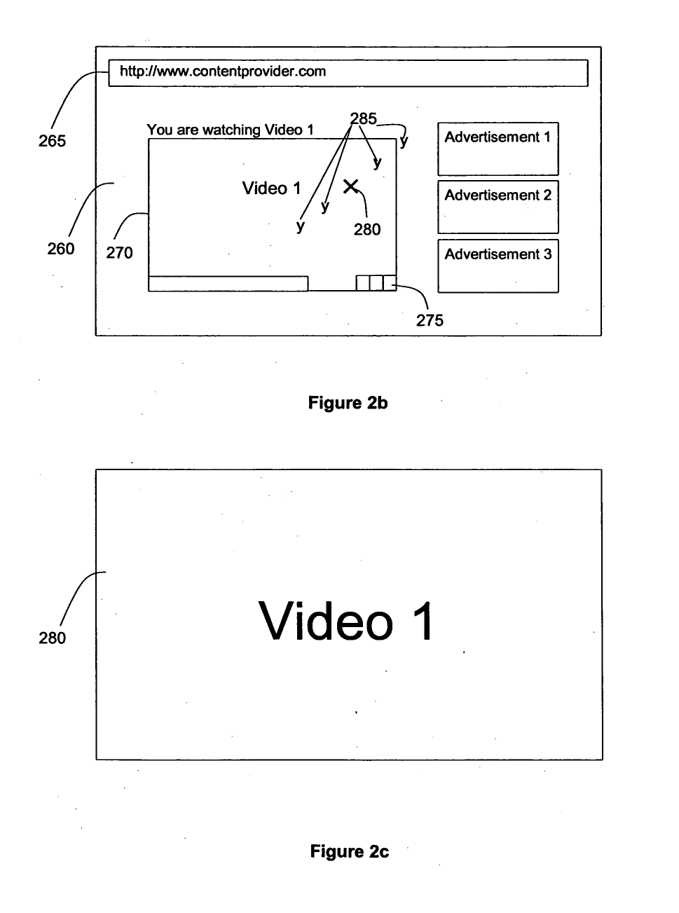

FIG. 2a illustrates user end network 200. User end network 200 includes television display 210, set top box 105, Input/Output (I/O) device 230 and remote control device 240. Television display 210 is a conventional television or other display device that displays content on a screen. I/O device 230 is any conventional I/O device including a keyboard or any other I/O device that connects to set top box 105 via either wired or wireless connection to allow a user to input data. Remote control device 240 is a conventional remote control that allows users to interact with set top box 105 via a wireless connection to input data to set top box 105.

In accordance with the shown embodiment of the invention, television display 210 displays a representation of various video contents 220 available for viewing and a user will make a selection of one of video contents 220 to view using either I/O device 230 and/or remote control device 240. Step top box 105 in response to the selection retrieves the network address associated with the selected video content and transmit a request to retrieve the video content from the network address via server 110. The address may be Universal Resource Locator (URL), Internet Protocol (IP) address or any other identifier that indicates the location of the requested video data in the network. One skilled in the art will recognized that the arrangement of video contents 220 on television display 210 as shown in FIG. 2a is only meant for illustration and the exact arrangement of video contents 220 is left as a design choice. One skilled in the art will further recognize that in alternative embodiments a user may simply enter the address of desired video content without departing from this invention.

FIG. 2b illustrates “web page” mode content 260 provided by content provider processing systems 130. “Web page” mode content 260 includes at least video content 270 and other information such as, advertisements, news and/or thumbnails. “Web page” mode content 260 is associated with a network address such as, Uniform Resource Locator (URL) 265 or any form of address that allows for retrieval of video content 270 from a content provider system over a network. Sets of pre-defined coordinates 280 and 285 are also shown in FIG. 2b. Sets of pre-defined coordinates 280 and 285 are pixel locations in a display that will be discussed below and are not part of “web page” mode content 260. Full screen button 275 is proximate the perimeter of video content 270. Although full screen button 275 shown in FIG. 2b is located at the bottom right corner of video content 270, one skilled in the art will recognize that full screen button 275 may also be located in other locations in “web page” mode content 260 and FIG. 2b is purely meant to be illustrative and not conclusive. FIG. 2c illustrates the full screen mode of video content 270 in a customized browser 280 in which the entire display is used to display the video content without any “border” or “framing” of the content in the display.

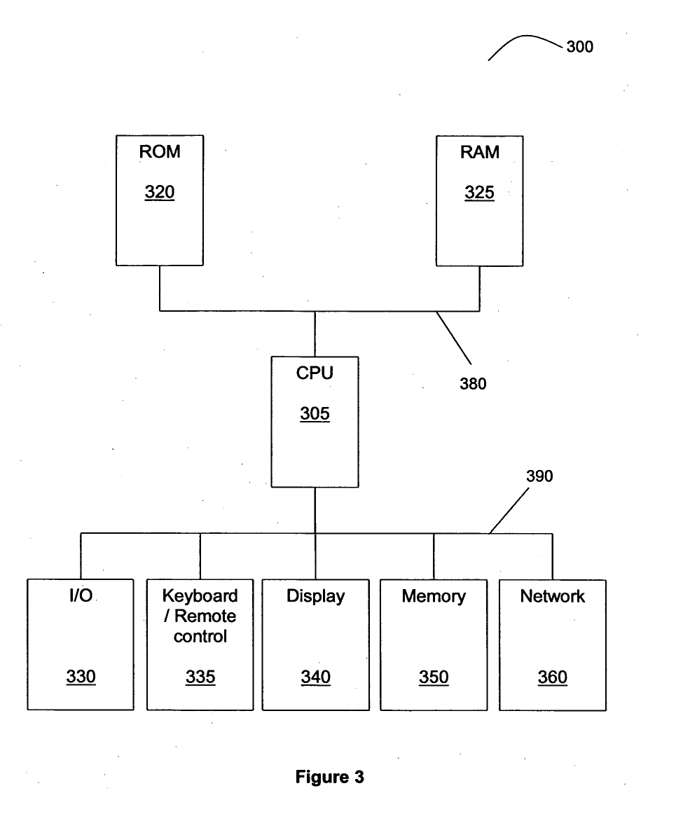

FIG. 3 illustrates a block diagram of processing system 300 in set top box 105 or other device that provides a full screen mode in accordance of this invention. Processing system 300 includes Central Processing Unit (CPU) 305. CPU 305 is a processor, microprocessor, or any combination of processors and microprocessors that execute instructions to perform the processes in accordance with the present invention. CPU 305 connects to memory bus 380 and Input/Output (I/O) bus 390. Memory bus 380 connects CPU 305 to memories 320 and 325 to transmit data and instructions between the memories and CPU 305. I/O bus 390 connects CPU 305 to peripheral devices to transmit data between CPU 305 and the peripheral devices. One skilled in the art will recognize that I/O bus 390 and memory bus 380 may be combined into one bus or subdivided into many other buses and the exact configuration is left to those skilled in the art.

A non-volatile memory 320, such as a Read Only Memory (ROM), is connected to memory bus 380. Non-volatile memory 320 stores instructions and data needed to operate various sub-systems of processing system 300 and to boot the system at start-up. One skilled in the art will recognize that any number of types of memory may be used to perform this function.

A volatile memory 325, such as Random Access Memory (RAM), is also connected to memory bus 380. Volatile memory 325 stores the instructions and data needed by CPU 305 to perform software instructions for processes such as the processes for providing a system in accordance with this invention. One skilled in the art will recognize that any number of types of memory may be used to provide volatile memory and the exact type used is left as a design choice to those skilled in the art.

I/O device 330, keyboard/remote control 335, display 340, memory 350, network 360, and any number of other peripheral devices connect to I/O bus 390 to exchange data with CPU 305 for use in applications being executed by CPU 305. I/O device 330 is any device that transmits and/or receives data from CPU 305. Keyboard/remote control 335 is any type of I/O that receives user input and transmits the input to CPU 305. Display 340 receives display data from CPU 305 and displays images on television display 210 for a user to view. Memory 350 is a device that transmits and receives data to and from CPU 305 for storing data to a media. Network 360 connects CPU 305 to a network for transmission of data to and from other processing systems such as server 110.

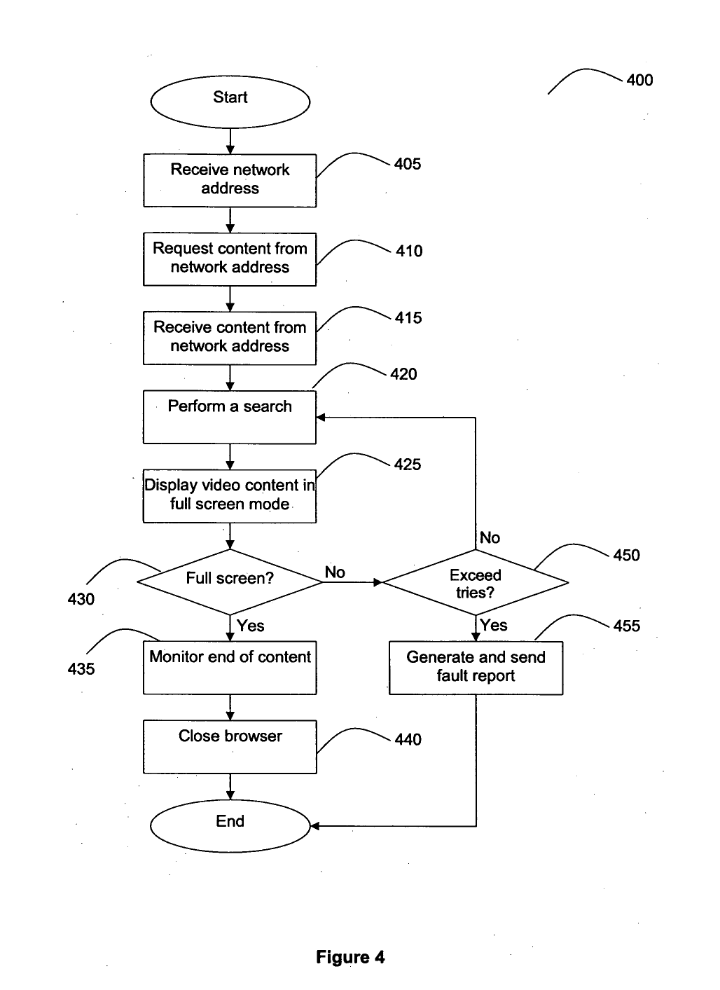

FIG. 4 illustrates a flowchart of a process performed in accordance with an embodiment of this invention to provide viewing of a selected video content in full screen mode. Process 400 begins in step 405 by receiving a network address. The network address may be received as a selection made by a user via I/O device 230 or remote control device 240 transmitted to set top box 105 or an input of network address as described above. Upon receipt of the selection, a network address that is associated with the selected video content is read from memory.

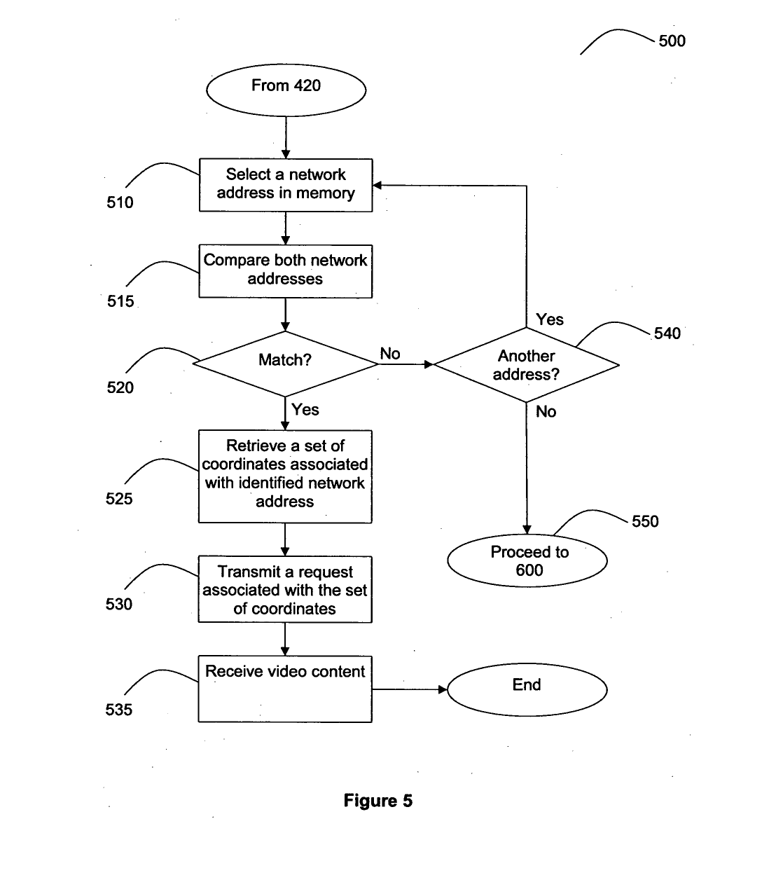

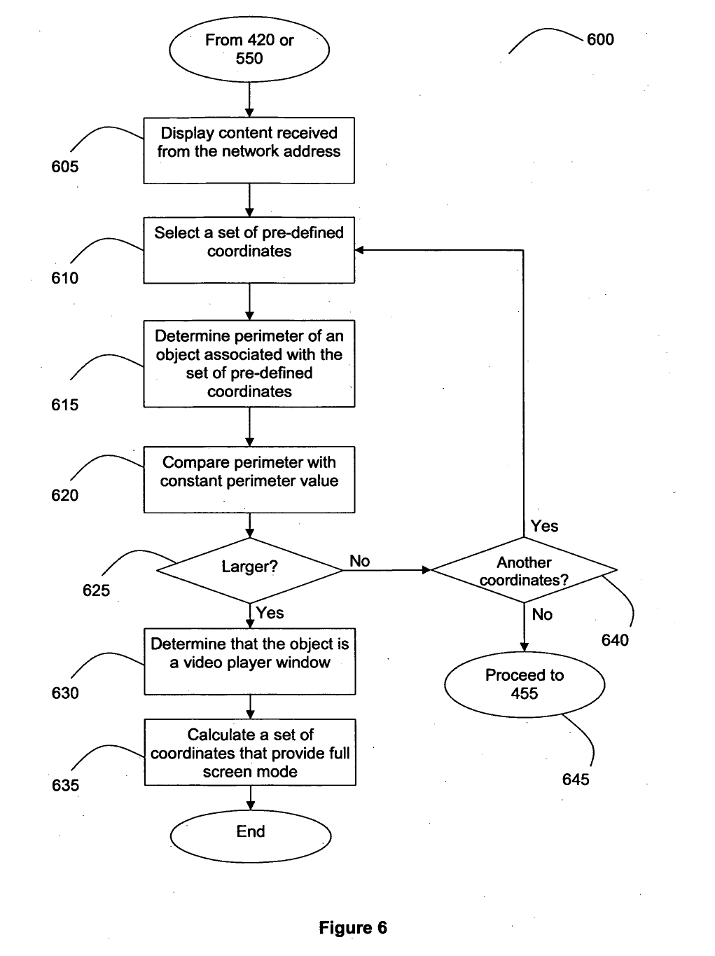

Process 400 then transmits a request for content to network address 265 in step 410. Process 400 then receives content 260 from network address 265 in step 415. In response to receiving content 260 from network address 265, process 400 searches the content for data that provides a full screen mode in step 420. Typically, the data that provides a full screen mode is an input including a set of coordinates of the location of full screen button 275 or similar object that is associated with video content 270. After the data that invokes the full screen mode is generated (as described below with references to FIGS. 5 and 6), process 400 then causes video content 270 to be displayed in full screen mode in response to the generated data in step 425.

Process 400 verifies video content 270 is displayed in full screen mode in step 430. If video content 270 is not in full screen mode, process 400 repeats from step 420. Alternatively, process 400 may determine the number of attempts to display the content in full screen mode and compare the number to a threshold value in step 450. The threshold for the number of attempts is pre-defined by a user and is left as a design choice. If number of attempts is greater than the threshold value, a fault report will be generated and sent to server 110 in step 455 and process 400 ends. A further elaboration of the fault report is provided below. If number of attempts does not exceed the threshold value, process 400 proceed to step 420.

If video content 270 is in full screen mode in customized browser 280, process 400 monitors for an end of video content in step 435. In some embodiments of this invention, process 400 monitors the network traffic transmitted to and received from the network address to detect specific patterns in the network traffic to determine that the video has finished playing. In one particular embodiment of this invention, process 400 monitors the network traffic for requests that are issued at the end of the playing of the video content by the system to retrieve video thumbnails (for recommended videos). Process 400 automatically closes customized browser 280 after detecting end of video content 270 and/or after user finish viewing video content in step 440. Process 400 then ends by returning to the previous display to show video contents 220.

As video content 270 is retrieved from various content providers, the exact process for detecting the end of video content 270 is dependent on the display data provided by content providers 130. A development team may analyse the network traffic for each content provider to identify network traffic patterns to indicate the end of the video playback, and configure the system accordingly to detect the end of video content. The updated process may then periodically or automatically be updated to set top box 105 via server 110 using the Windows ClickOnce™ technology or the likes.

In some embodiments of this invention, process 400 may monitor for an input from a user via an I/O device such as I/O controller 230 or remote controller 240 transmitted prior to step 440. Function that may be associated with the input may include, but not limited to, restoring the customized browser to a non-full screen mode, terminating viewing video content, returning to previous screen, and closing the customized browser. One skilled in the art will recognize that the functions provided and implementations are a design choice left to those skilled in the art.

In another embodiment of this invention, process 400 may determine whether information associated with the data includes a function for invoking a full screen mode. In particular, the information is obtained via an accessibility feature that makes the data in content 260 easier to see, hear, and use. For example, in some data provided by some content providers, full screen button 275 may be represented by word such as “Full screen” instead of a picture representation of an enlarged button. Hence, process 400 may perform a text verification of full screen button 275 instead of verification via an interactive display format.

FIG. 5 illustrates process 500. Process 500 is an embodiment of a process for performing step 420 of process 400. Process 500 begins in step 510 by selecting a network address from a pre-stored list of network addresses stored in memory. In step 515, the selected network address from step 510 is then compared with the network address received in step 405. If selected network address matches the received address in step 520, process 500 proceeds to step 525. Otherwise, process 500 determines whether any addresses remain in pre-stored list of network addresses in step 540. If no addresses remain in the list of network addresses and none of the pre-stored list of network addresses matches the received network address, process 500 proceeds to process 600 described below.

In step 525, a set of coordinates associated with the matched network address is retrieved from memory. Process 500 then transmits a request associated with the set of coordinates to the content provider system in step 530. In this case, the request is an indication of a selection of the set of coordinates which correspond to full screen button 275. In one embodiment of this invention, an Application Programming Interface (API) is used to perform step 530 by generating a request using the set of coordinates. Process 500 then receives video content in step 535 and process 500 ends by proceeding to step 425 in process 400.

FIG. 6 illustrates process 600. Process 600 is performed in response to step 420 of process 400 or step 550 of process 500. Process 600 begins in step 605 by displaying content 260 received from the network address received in step 405. Process 600 selects a set of pre-defined coordinates in step 610. An example of sets of pre-defined coordinates (representing a pixels or set of pixels) is shown as reference numbers 280 and 285 in FIG. 2b. In most content provided by content providers, an object that displays video content 270 typically occupies the center of display. Hence, the set of pre-defined coordinates (representing a pixel or set of pixels) is usually selected by using the center of display indicated as X 280. The sets of pre-defined coordinates (representing a pixel or set of pixels) marked y 285 provide alternate coordinates in case X 280 is not in video content 270.

In step 615, process 600 determines the perimeter of an object associated with the set of pre-defined coordinates. The determined perimeter is then compared with a constant perimeter value to determine whether the object is a video player window in step 625. As the perimeter of video player window varies for different content providers, the choice of the constant perimeter value is left to one skilled in the art to determine based upon the displays provided by the content provider. The constant perimeter value is stored in memory and may be updated periodically.

If the determined perimeter is larger than the constant perimeter value, process 600 determines that the object is a video player window in step 630. However, if the determined perimeter is not larger than the constant perimeter value, process 600 proceeds to step 640.

In step 640, process 600 determines if all the sets of pre-defined coordinates have been selected. If the process determines that there is another set of pre-defined coordinates in step 640, process 600 repeats from step 610 with a new set of coordinates. Otherwise, process 600 proceeds to step 645. For illustrative purposes, subsequent sets of pre-defined coordinates are marked as y 285 in FIG. 2b. The exact sequence of selection of the set of pre-defined coordinates and the number of sets of pre-defined coordinates are left to one skilled in the art. The set of pre-defined coordinates for the content from different content providers may be periodically updated.

In step 645 and step 455, a fault report is generated and sent to server 110. The fault report includes, but not limited to, the network address from which the content was received. Upon receiving the fault report, a development team may simulate the search process and update the set of coordinates associated with the network address. The choice of the set of pre-defined coordinates may also be updated. The network address and the set of coordinates associated with the network address are automatically updated in memory periodically for use in step 510 in process 500. Similarly, the updated set of pre-defined coordinates is also automatically updated in memory periodically for use in step 610 in process 600.

After step 630, process 600 proceeds to step 635. In step 635, process 600 calculates a set of coordinates that provide full screen mode. In one embodiment of this invention, process 600 calculates the set of coordinates in the following manner. Minimum Y axis and maximum X axis of the determined video player window are obtained. Minimum Y axis and maximum X axis of the determined video player window are then subtracted by a constant Y value and a constant X value respectively. Essentially, the position of full screen button 270 varies and is dependent on various content providers. Hence, the choice of the constant X value and constant Y value are left to one skilled in the art to determine. Constant X value and constant Y value are stored in memory and may be periodically updated.

The above describes particular embodiments of a process for displaying a full screen mode of a video content streamed from the Internet in accordance with this invention. It is foreseen that those skilled in the art can and will design alternative embodiments that infringe on this invention as set forth in the following claims for the description of these embodiments.

1-76. (canceled)

77. A system for providing full screen mode of video content streamed from a content provider system over network comprising:
a processing unit;
instructions for directing said processing unit to:
receive a network address;
request content from said network address;
receive said content associated with said network address over said network;
perform a search of said content for data that provides a full screen mode, wherein said instructions to perform said search comprises instructions for directing said processing unit to:
identify said network address in a pre-stored list network addresses; and
retrieve a set of coordinates associated with said identified network address;
generate said data that provides said full screen mode; and
display video content from said content in said full screen mode;
and
a media readable by said processing storing said instructions.

78. The system according to claim 77, wherein said instructions to generate said data comprises:
instructions for directing said processing unit to:
transmit a request associated with said set of coordinates associated with said identified network address.

79. The system according to claim 78 further comprising:
instructions for directing said processing unit to:
receive said video content to provide said full screen mode in response to transmitting said request.

80. The system of claim 78, wherein said instructions to transmit said request comprises:
instructions for directing said processing unit to:
generate a request with an Application Programming Interface (API) that includes said set of coordinates.

81. The system according to claim 77, wherein responsive to said pre-stored list of network addresses having no remaining network addresses and responsive none of said pre-stored list of network addresses matching said network address, said instructions to perform a search from said content for data that provide a full screen mode comprises:
instructions for directing said processing unit to:
select a set of pre-defined coordinates;
determine a perimeter of an object that contains said set of predefined coordinates;
determine said object is a video player window;
calculate a set of coordinates from said object that provides said full screen mode; and
generate a response that includes said set of coordinates.

82. The system according to claim 81, wherein said instructions to calculate said set of coordinates comprises:
instructions for directing said processing unit to:
obtain minimum Y axis and maximum X axis of said video player window;
subtract said minimum Y axis of said video player window with a constant Y value; and
subtract said maximum X axis of said video player window with a constant X value to determine said set of coordinates.

83. The system according to claim 81, wherein said instructions to determine said object is said video player window comprises:
instructions for directing said processing unit to:
compare said perimeter of said object with a constant perimeter value; and
determine said object is said video player window responsive to said perimeter of said object being larger than said constant perimeter value.

84. The system according to claim 83, wherein said set of pre-defined coordinates is one of a plurality of sets of pre-defined coordinates.

85. The system according to claim 84 further comprising:
instructions for directing said processing unit to:
select a subsequent one of said plurality of set of pre-defined coordinates in response that said perimeter of said object is not larger than said constant perimeter value;
determine a perimeter of a subsequent object that contains said subsequent one of said plurality of sets of pre-defined coordinates;
determine said subsequent object is a video player window; and
calculate a set of coordinates from said object that provide said full screen mode.

86. The system according to claim 77 further comprising:
instructions for directing said processing unit to:
verify said video content is being displayed in said full screen mode.

87. The system according to claim 86 further comprising:
instructions for directing said processing unit to:
repeat said instructions to perform said search from said content for data that provide said full screen mode, said instructions to display video content from said content in said full screen mode and said instructions to verify said video content in response that said video content is not in said full screen mode after performing a pre-defined number times of said instructions to verify said video content.

88. The method according to claim 86 further comprising:
instructions for directing said processing unit to:
send a fault report to a server in response that said video content is not in said full screen mode after performing a pre-defined number times of said instructions to verify said video content.

89. The system according to claim 88 further comprising:
instructions for directing said processing unit to:
update a plurality of sets of pre-defined coordinates in accordance to said network address that failed to display said full screen mode.

90. The system according to claim 77 further comprising:
instructions for directing said processing unit to:
determine information associated with said data to determine whether said information contains an indication for full screen mode.

91. The system according to claim 77 further comprising:
instructions for directing said processing unit to:
display said video content from said content in said full screen mode in a customised browser;
detect an end of said content associate to said network address; and
close said customised browser in response to said end of said content associate with said network address.

92. The system according to claim 77 further comprising:
instructions for directing said processing unit to:
receive a selection from a user prior to said step of closing said customised browser;
identify a function associated to said selection; and
perform said function.

93. The system according to claim 92, wherein said function restores said customised browser to a non-full screen mode.

94. The system according to claim 91, wherein said instructions to detect said end of said content comprises:
instructions for directing said processing unit to:
monitor network traffic of content transmitted to and received from said network address to detect said end of a display of said video content associated with said network address.

95. The system according to claim 94 wherein said instructions to monitor network traffic comprises:
instructions for directing said processing unit to:
detect a specific pattern in said network traffic to determine said end of said content associated with said network address.

96. The system according to claim 95 wherein said instructions to detect said specific pattern comprises:
instructions for directing said processing unit to:
detect a request for retrieving video thumbnails in said network traffic.
